(19) United States
(12) Patent Application Publication
(10) Pub. No.: US 2025/0229555 A1
(43) Pub. Date: Jul. 17, 2025

(54) LIQUID EJECTION DEVICE AND LIQUID EJECTION SYSTEM

(71) Applicant: SEIKO EPSON CORPORATION, Tokyo (JP)

(72) Inventors: Jun SHIMAZAKI, SHIOJIRI-SHI (JP); Shuhei HARADA, CHINO-SHI (JP)

(21) Appl. No.: 19/014,952

(22) Filed: Jan. 9, 2025

(30) Foreign Application Priority Data
Jan. 12, 2024 (JP) 2024-003080

(51) Int. Cl. B41J 25/34; B41J 2/175; B41J 29/54

(52) U.S. Cl. CPC B41J 25/34; B41J 2/175; B41J 29/54

(57) ABSTRACT

A liquid ejection device is a liquid ejection device being coupled to a mounting unit on which a liquid accommodation body configured to accommodate a liquid is mounted, the liquid ejection device including an ejection unit configured to eject the liquid, a device flow path extending from the ejection unit, and a reception unit configured to receive the liquid, wherein the device flow path includes a coupling unit to be coupled to the mounting unit, and the reception unit is positioned vertically below the coupling unit.

The present application is based on, and claims priority from JP Application Serial Number 2024-003080, filed Jan. 12, 2024, the disclosure of which is hereby incorporated by reference herein in its entirety.

### BACKGROUND

### 1. Technical Field

The present disclosure relates to a liquid ejection device and a liquid ejection system.

### 2. Related Art

JP-A-2021-24178 describes a liquid ejection device that can be coupled to a mounting unit on which a liquid accommodation body is mounted. When the mounting unit and the liquid ejection device are coupled to each other, a liquid is supply from the liquid accommodation body to the liquid ejection device.

The mounting unit is removed from such a liquid ejection device in some cases. In such a case, the liquid may drip down from a coupling unit of the liquid ejection device, and there may be the risk of contamination in the periphery of the liquid ejection device.

### SUMMARY

In order to solve the above-mentioned problem, a liquid ejection device is a liquid ejection device being coupled to a mounting unit on which a liquid accommodation body configured to accommodate a liquid is mounted, the liquid ejection device including an ejection unit configured to eject the liquid, a device flow path extending from the ejection unit, and a reception unit configured to receive the liquid, wherein the device flow path includes a coupling unit to be coupled to the mounting unit, and the reception unit is positioned vertically below the coupling unit.

In order to solve the above-mentioned problem, a liquid ejection system includes the liquid ejection device described above and the mounting unit.

### BRIEF DESCRIPTION OF THE DRAWINGS

FIG. 1 is a perspective view illustrating an example of a liquid ejection system.

FIG. 2 is a front view schematically illustrating a device flow path and a unit flow path.

FIG. 3 is a bottom view of a liquid ejection device, illustrating a coupling unit.

FIG. 4 is a side view of the coupling unit.

FIG. 5 is a side view of the coupling unit that is displaced from the state illustrated in FIG. 4 to a separation position.

FIG. 6 is a perspective view of the coupling unit.

FIG. 7 is a side view of the coupling unit that is displaced from the state illustrated in FIG. 6 to the separation position.

FIG. 8 is a top view of the mounting unit, illustrating a joining unit.

FIG. 9 is a top view of the coupling unit and the joining unit.

FIG. 10 is a perspective view of the coupling unit and the joining unit.

FIG. 11 is a perspective view in which the coupling unit is displaced from the state illustrated in FIG. 10 to a coupling position.

FIG. 12 is a perspective view in which a lock member is displaced from the state illustrated in FIG. 11 to a lock position.

FIG. 13 is a cross-sectional view taken along the line 13-13 in FIG. 9.

FIG. 14 is a cross-sectional view taken along the line 14-14 in FIG. 9.

FIG. 15 is a cross-sectional view taken along the line 15-15 in FIG. 9.

### DESCRIPTION OF EMBODIMENTS

With reference to the drawings, an embodiment of a liquid ejection system including a liquid ejection device is described below. The liquid ejection device is, for example, an ink jet-type printer that performs printing of an image such as characters and photographs on a medium such as a sheet and fabric by ejecting ink, which is an example of a liquid.

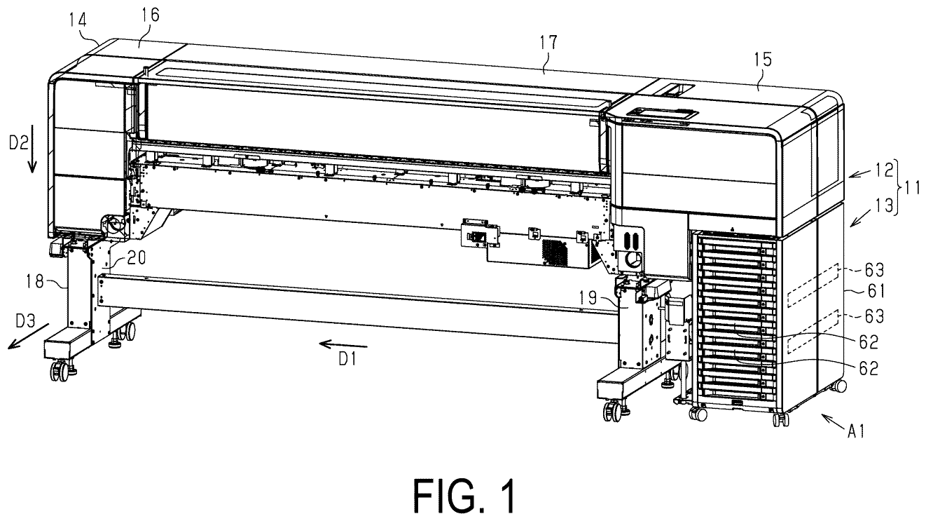

As illustrated in FIG. 1, a liquid ejection system 11 includes a liquid ejection device 12 and a mounting unit 13. The liquid ejection device 12 is configured to eject a liquid. The mounting unit 13 is configured to be coupled to the liquid ejection device 12. In FIG. 1, the mounting unit 13 is coupled to the liquid ejection device 12. The mounting unit 13 is configured so that a liquid accommodation body 63, which is described later, is mounted thereon. When the mounting unit 13 is coupled to the liquid ejection device 12, the liquid can be supplied from the mounting unit 13 to the liquid ejection device 12.

### Liquid Ejection Device

First, the liquid ejection device 12 is described.

The liquid ejection device 12 includes a device casing body 14. For example, the device casing body 14 is elongated in one direction. In an example, the device casing body 14 is elongated in a scanning direction D1. The device casing body 14 includes a first casing body portion 15, a second casing body portion 16, and a center casing body portion 17. The first casing body portion 15 and the second casing body portion 16 are portions positioned at the ends of the device casing body 14 in the scanning direction D1. The center casing body portion 17 is a portion adjacent to the first casing body portion 15 and the second casing body portion 16. The center casing body portion 17 is sandwiched between the first casing body portion 15 and the second casing body portion 16 in the scanning direction D1. The first casing body portion 15, the center casing body portion 17, and the second casing body portion 16 are arrayed in the stated order in the scanning direction D1.

The liquid ejection device 12 includes a leg unit 18. The leg unit 18 supports the device casing body 14. In an example, the leg unit 18 extends downward from the first casing body portion 15 and the second casing body portion 16. The leg unit 18 includes a first leg portion 19 and a second leg portion 20. The first leg portion 19 is a portion extending downward from the first casing body portion 15. The second leg portion 20 is a portion extending downward from the second casing body portion 16.

The liquid ejection device 12 may be configured so that the mounting unit 13 is accommodated in a foot space of the liquid ejection device 12. For example, the liquid ejection device 12 may define an arrangement space A1. In an example, the device casing body 14 and the leg unit 18 define the arrangement space A1. The arrangement space A1 is a region in which the mounting unit 13 coupled to the liquid ejection device 12 is accommodated. The arrangement space A1 is a region overlapping with the device casing body 14 as viewed in the vertical direction D2. In an example, the arrangement space A1 is a region vertically below the first casing body portion 15. Thus, as viewed in the vertical direction D2, the device casing body 14 overlaps with the mounting unit 13. Specifically, as viewed in the vertical direction D2, the first casing body portion 15 overlaps with the mounting unit 13. The mounting unit 13 is positioned in the arrangement space A1. With this, the risk of increasing the foot space in the liquid ejection system 11 can be lowered.

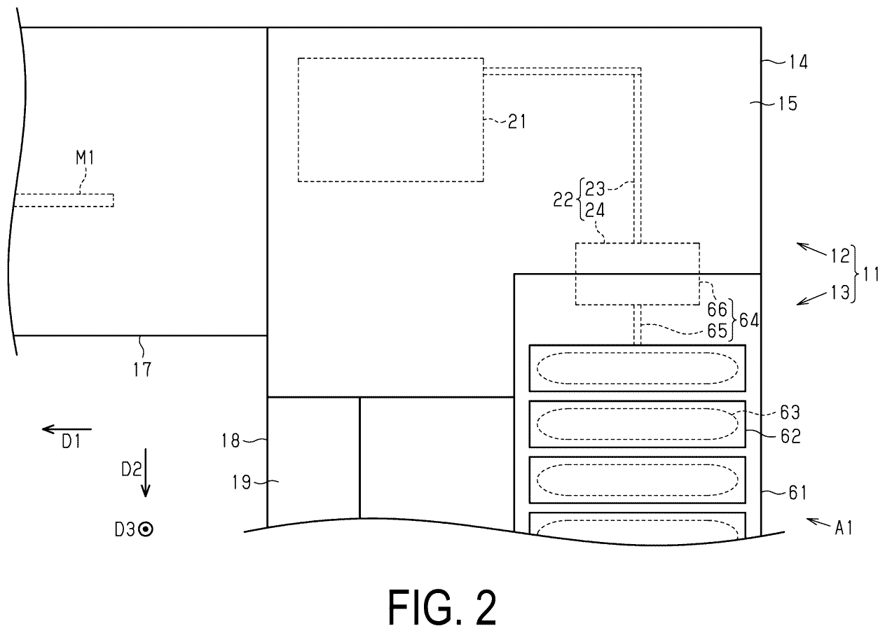

As illustrated in FIG. 2, the liquid ejection device 12 includes an ejection unit 21. The ejection unit 21 is configured to eject a liquid. The ejection unit 21 ejects the liquid onto a medium M1. For example, the ejection unit 21 ejects the liquid onto the medium M1 transported inside the device casing body 14. In the liquid ejection device 12, the medium M1 is transported in a transport direction D3. The transport direction D3 is a direction different from the vertical direction D2. In an example, the transport direction D3 is a direction also different from the scanning direction D1. For example, the transport direction D3 is a direction extending from the rear side to the front side of the device casing body 14. After printing is performed, the medium M1 is discharged from the front surface of the device casing body 14. The ejection unit 21 ejects the liquid onto the medium M1. With this, an image is printed on the medium M1.

The ejection unit 21 is configured to scan the medium M1. The ejection unit 21 is configured to move in the scanning direction D1. Specifically, the ejection unit 21 moves in the scanning direction D1 and the direction opposite thereto inside the device casing body 14. With this, the ejection unit 21 can eject the liquid over the entire width of the medium M1. As described above, in an example, the ejection unit 21 is a serial-head type. The ejection unit 21 may be a line-head type that can eject the liquid simultaneously over the entire width of the medium M1.

The liquid ejection device 12 includes a device flow path 22. The device flow path 22 is configured so that the liquid flows therethrough. The device flow path 22 extends from the ejection unit 21. The device flow path 22 is coupled to the ejection unit 21 and the mounting unit 13. The liquid is supplied from the mounting unit 13 to the ejection unit 21 via the device flow path 22.

The device flow path 22 includes one or more flow portions 23. The flow portion 23 is a portion in which the liquid flows. The flow portion 23 is coupled to the ejection unit 21. The flow portion 23 extends inside the device casing body 14. For example, the flow portion 23 includes a tube. The device flow path 22 includes the same number of flow portions 23 as the liquid accommodation bodies 63. With this, the device flow path 22 can supply the liquid from the plurality of liquid accommodation bodies 63 to the ejection unit 21.

The device flow path 22 includes a coupling unit 24. The coupling unit 24 is configured to be coupled to the mounting unit 13. In an example, the coupling unit 24 is configured to be coupled to the mounting unit 13 positioned vertically therebelow. For example, the mounting unit 13 is positioned directly below the coupling unit 24. With this, the coupling unit 24 can be coupled to the mounting unit 13.

The coupling unit 24 configures the upstream end of the device flow path 22. Specifically, the coupling unit 24 configures the upstream end of the device flow path 22 in the direction in which the liquid flows. The coupling unit 24 is coupled to the flow portion 23. For example, the coupling unit 24 is a joint.

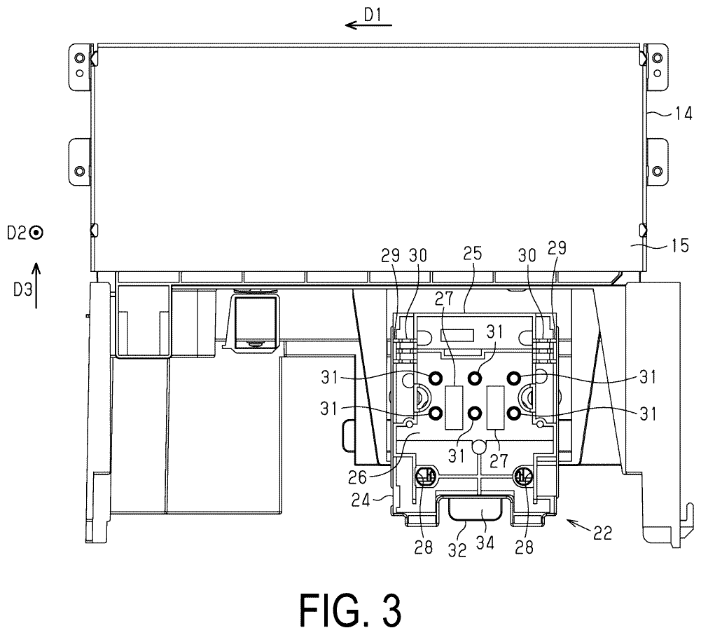

As illustrated in FIG. 3, the coupling unit 24 is positioned so as to be exposed from the device casing body 14. In an example, the coupling unit 24 is exposed from below the device casing body 14 in a visually recognizable manner. Specifically, the coupling unit 24 is exposed from below the first casing body portion 15 in a visually recognizable manner. The coupling unit 24 is fixed to the device casing body 14.

The coupling unit 24 includes a coupling body 25. The coupling body 25 retains the flow portion 23. For example, the coupling body 25 is a resin case. The coupling body 25 extends in the vertical direction D2. The coupling body 25 includes a coupling surface 26. The coupling surface 26 is a surface facing the mounting unit 13. In an example, the coupling surface 26 faces downward.

The coupling body 25 includes one or more pressure reception portions 27. In an example, the coupling body 25 includes two pressure reception portions 27. The pressure reception portion 27 is a portion that receives a pressure from the mounting unit 13 when the coupling unit 24 is removed from the mounting unit 13. The pressure reception portion 27 protrudes from the coupling surface 26. The pressure reception portion 27 protrudes to approach the mounting unit 13. For example, the pressure reception portion 27 protrudes downward from the coupling surface 26.

In the coupling body 25, one or more guide holes 28 may open. In an example, in the coupling body 25, two guide holes 28 open. The guide hole 28 opens in the coupling surface 26. The guide hole 28 passes through the coupling body 25. For example, the guide hole 28 passes through the coupling body 25 in the vertical direction D2. The mounting unit 13 is inserted into the guide hole 28. With this, the mounting unit 13 is guided with respect to the liquid ejection device 12. The mounting unit 13 is inserted into the guide hole 28. With this, the position of the mounting unit 13 with respect to the coupling unit 24 is adjusted. Thus, the coupling unit 24 is easily coupled to the mounting unit 13.

The coupling body 25 may include one or more insertion portions 29. In an example, the coupling body 25 includes two insertion portions 29. The insertion portion 29 is a portion into which the mounting unit 13 is inserted. A portion of the mounting unit 13, which is different from the portion inserted into the guide hole 28, is inserted into the insertion portion 29. The insertion portion 29 protrudes from the coupling surface 26. The insertion portion 29 protrudes from the coupling surface 26 to approach the mounting unit 13. For example, the insertion portion 29 protrudes downward from the coupling surface 26.

In the insertion portion 29, an insertion opening 30 opens. The insertion opening 30 opens in a direction different from the guide hole 28. The insertion opening 30 opens in the insertion portion 29 in a direction parallel to the coupling surface 26. In an example, the insertion opening 30 opens in the transport direction D3. The insertion opening 30 passes through the insertion portion 29 in the transport direction D3. The mounting unit 13 is inserted into the insertion opening 30. With this, the risk that the coupling unit 24 comes off from the mounting unit 13 can be lowered.

The coupling unit 24 includes one or more coupling tubes 31. The coupling unit 24 includes the same number of coupling tubes 31 as the flow portions 23. In an example, the coupling unit 24 includes six coupling tubes 31. The coupling tube 31 is attached to the coupling body 25. the coupling tube 31 is positioned to protrude from the coupling surface 26. In an example, the coupling tube 31 faces downward. The six coupling tubes 31 is positioned to avoid the pressure reception portion 27.

The coupling tube 31 is coupled to the flow portion 23. The coupling tube 31 is inserted into the mounting unit 13, or the mounting unit 13 is inserted into the coupling tube 31. With this, the coupling unit 24 is coupled to the mounting unit 13. In an example, the coupling tube 31 is inserted into the mounting unit 13, and then is coupled to the mounting unit 13. When the coupling tube 31 is coupled to the mounting unit 13, the liquid flows to the flow portion 23 via the coupling tube 31.

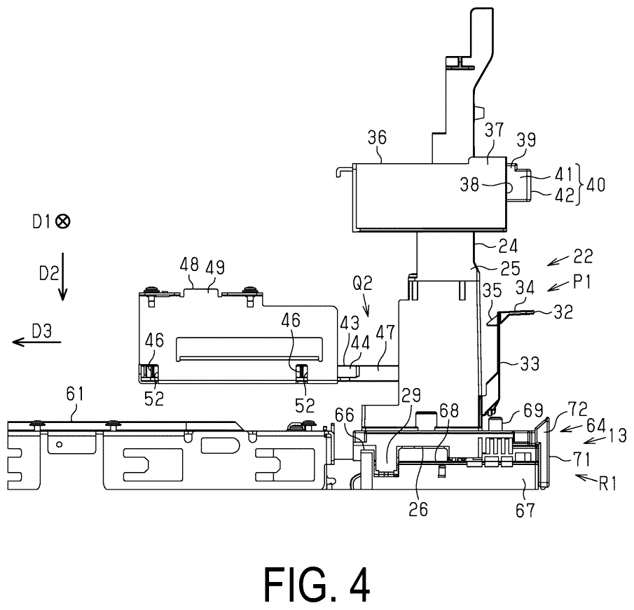

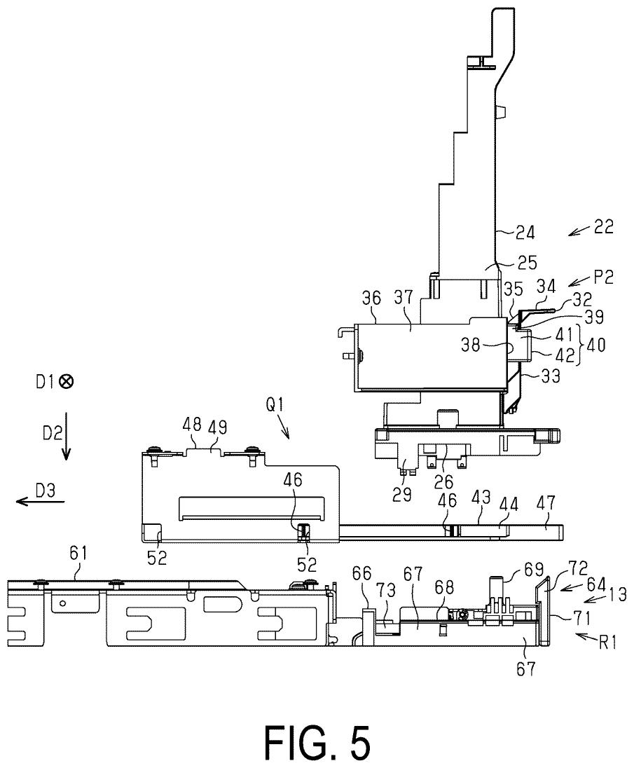

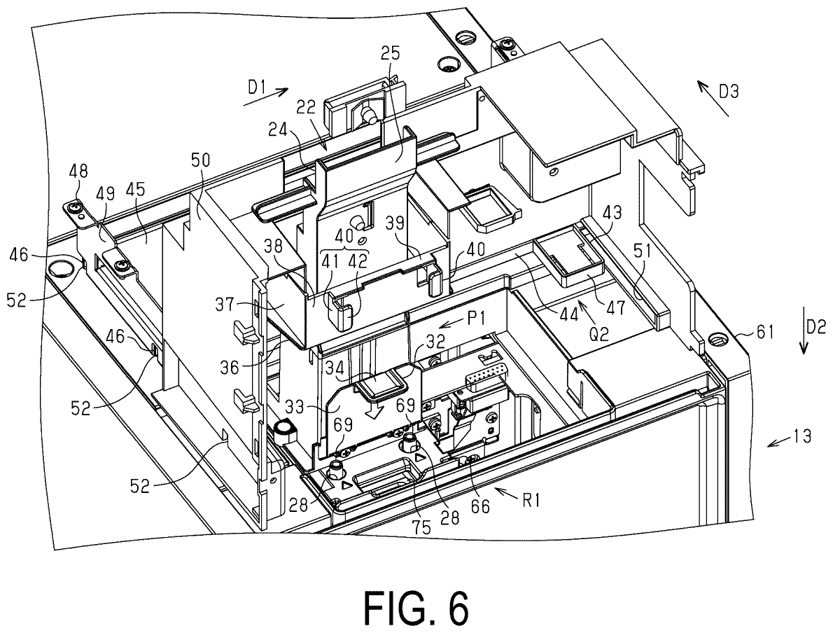

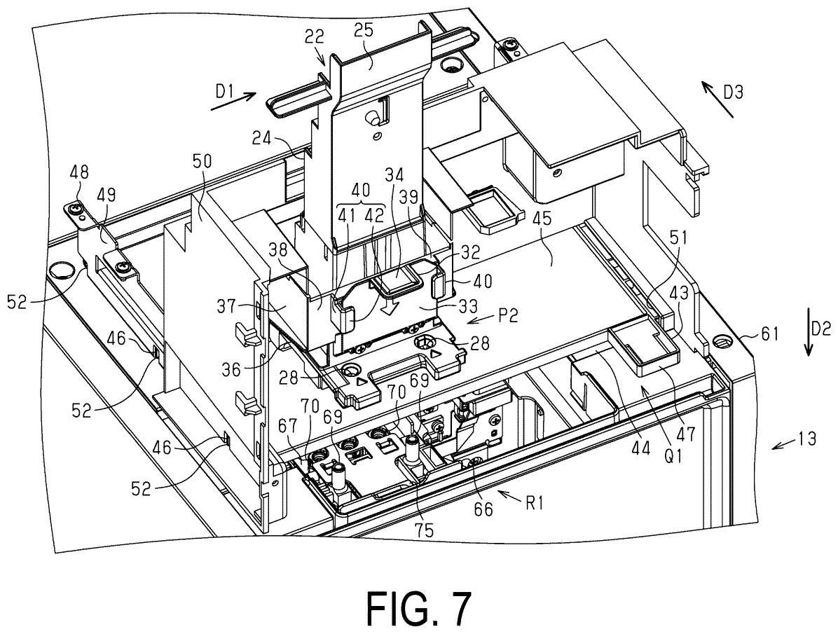

As illustrated in FIG. 4, FIG. 5, FIG. 6, and FIG. 7, the coupling unit 24 may be configured to move between a coupling position P1 and a separation position P2. In an example, the coupling unit 24 moves in the vertical direction D2 and the direction opposite thereto. With this, the coupling unit 24 moves between the coupling position P1 and the separation position P2.

The coupling position P1 is a position at which the coupling unit 24 is coupled to the mounting unit 13. The coupling position P1 is a position approaching the mounting unit 13. The coupling unit 24 illustrated in FIG. 4 and FIG. 6 is positioned at the coupling position P1. The coupling unit 24 moves in the vertical direction D2. With this, the coupling unit 24 is displaced from the separation position P2 to the coupling position P1.

The separation position P2 is a position at which the coupling unit 24 is separated from the mounting unit 13. The separation position P2 is a position at which the coupling unit 24 is separated from the mounting unit 13. At the separation position P2, the coupling unit 24 is not coupled to the mounting unit 13. The coupling unit 24 illustrated in FIG. 5 and FIG. 7 is positioned at the separation position P2. The separation position P2 is a position above the coupling position P1. The coupling unit 24 moves in the direction opposite to the vertical direction D2. With this, coupling unit 24 is displaced from the coupling position P1 to the separation position P2.

The coupling unit 24 may include a contact member 32. The contact member 32 is a member that contacts with a retaining unit 36, which is described later. Specifically, when the coupling unit 24 is positioned at the separation position P2, the contact member 32 contacts with the retaining unit 36. The contact member 32 is attached to the coupling body 25. In an example, the contact member 32 is configured to extend from the rear surface of the coupling body 25.

The contact member 32 includes an extension portion 33. The extension portion 33 is a portion extending along the coupling body 25. The extension portion 33 extends rearward from the rear surface of the coupling body 25, and then extends upward along the rear surface of the coupling body 25. The base end of the extension portion 33 is attached to the coupling body 25.

The contact member 32 includes an operation portion 34. The operation portion 34 is a portion configured to be gripped. For example, the operation portion 34 is gripped by a user. The operation portion 34 extends from the extension portion 33. Specifically, the operation portion 34 extends rearward from the distal end of the extension portion 33. A user moves the coupling unit 24 between the coupling position P1 and the separation position P2 while gripping the operation portion 34.

The contact member 32 includes a projection 35. The projection 35 is a portion that hooks onto the retaining unit 36. The projection 35 protrudes from the extension portion 33. Specifically, the projection 35 protrudes frontward from the distal end of the extension portion 33. The projection 35 is positioned between the extension portion 33 and the coupling body 25.

The liquid ejection device 12 may include the retaining unit 36. The retaining unit 36 is configured to retain the coupling unit 24. Specifically, the retaining unit 36 retains the coupling unit 24 positioned at the separation position P2. The retaining unit 36 retains the coupling unit 24. With this, the risk that the coupling unit 24 is unintentionally displaced from the separation position P2 to the coupling position P1 can be lowered. For example, when the mounting unit 13 is arranged in the arrangement space A1 while the coupling unit 24 is positioned at the coupling position P1, the coupling unit 24 may collide with the mounting unit 13.

The retaining unit 36 includes a base member 37. The base member 37 is configured to surround the coupling unit 24. The base member 37 surrounds the coupling body 25. In an example, the base member 37 surrounds the coupling body 25 regardless of the position of the coupling body 25. Specifically, when the coupling unit 24 is positioned at the coupling position P1, the base member 37 surrounds the upper part of the coupling body 25. When the coupling unit 24 is positioned at the separation position P2, the base member 37 surrounds the lower part of the coupling body 25. The coupling unit 24 is displaced while the coupling body 25 is surrounded by the base member 37.

The base member 37 includes a guide surface 38. The guide surface 38 is a surface that faces the contact member 32. Specifically, when the coupling unit 24 is positioned at the separation position P2, the guide surface 38 faces the extension portion 33. In an example, the guide surface 38 faces rearward.

The retaining unit 36 includes a retaining member 39. The retaining member 39 is a member that contacts with the contact member 32. The retaining member 39 extends from the base member 37. The retaining member 39 extends from the upper end of the base member 37. The retaining member 39 extends rearward from the guide surface 38. The retaining member 39 contacts with the projection 35. Specifically, the projection 35 hooks onto the retaining member 39. With this, the retaining member 39 retains the contact member 32. As a result, the retaining unit 36 retains the coupling unit 24.

The retaining unit 36 includes one or more guide members 40. In an example, the retaining unit 36 includes two guide members 40. The guide member 40 is a member that guides the contact member 32. Specifically, the guide member 40 guides the extension portion 33. The guide member 40 extends from the base member 37. The guide member 40 extends rearward from the guide surface 38. The two guide members 40 are positioned to sandwich the contact member 32 in the scanning direction D1.

The guide member 40 includes a first guide piece 41 and a second guide piece 42. The first guide piece 41 extends vertically from the guide surface 38. The two first guide pieces 41 are positioned to sandwich the extension portion 33 in the scanning direction D1. The second guide piece 42 extends from the first guide piece 41. The second guide piece 42 extends vertically to the first guide piece 41 from the distal end of the first guide piece 41. The two second guide pieces 42 extend to approach each other.

When the coupling unit 24 is displaced from the coupling position P1 to the separation position P2, the extension portion 33 is inserted between the base member 37 and the second guide piece 42. In this state, the guide member 40 guides the contact member 32. When the coupling unit 24 is positioned at the separation position P2, the projection 35 hooks onto the retaining member 39. With this, the retaining unit 36 retains the coupling unit 24 at the separation position P2. When the operation portion 34 is pulled, the projection 35 is removed from the retaining member 39, the coupling unit 24 can be displaced from the separation position P2 to the coupling position P1.

The liquid ejection device 12 includes a reception unit 43. The reception unit 43 is configured to receive the liquid. The reception unit 43 receives the liquid dripping down from the coupling unit 24. When the coupling unit 24 is removed from the mounting unit 13, the liquid may drip down from the coupling unit 24. Specifically, the liquid may drip down from the coupling tube 31. In particular, the coupling tube 31 faces downward, and hence the liquid easily drips down from the coupling tube 31. The reception unit 43 receives the liquid dripping down from the coupling tube 31. With this, the risk of contamination in the periphery of the liquid ejection device 12 can be lowered.

The reception unit 43 is positioned vertically below the coupling unit 24. In other words, the reception unit 43 is positioned directly below the coupling unit 24. With this, the reception unit 43 receives the liquid from the coupling unit 24. The reception unit 43 is positioned vertically below the coupling unit 24. With this, coupling between the coupling unit 24 and the mounting unit 13 may be interrupted. This is because the coupling tube 31 faces downward. For example, in a case in which the coupling tube 31 faces rearward, even when the reception unit 43 is positioned below the coupling unit 24, the coupling unit 24 can be coupled to the mounting unit 13 without interruption by the reception unit 43.

The reception unit 43 is configured to move between a reception position Q1 and a retraction position Q2. In an example, the reception unit 43 moves in the transport direction D3 and the direction opposite thereto. With this, the reception unit 43 moves between the reception position Q1 and the retraction position Q2. The reception unit 43 may be displaced by moving in the scanning direction D1, or may be displaced by rotation.

The reception position Q1 is a position at which the reception unit 43 receives the liquid from the coupling unit 24. The reception position Q1 is a position vertically below the coupling unit 24. The reception position Q1 is a position directly below the coupling unit 24. The reception position Q1 is a position overlapping with the coupling unit 24 as viewed in the vertical direction D2. The reception unit 43 illustrated in FIG. 5 and FIG. 7 is positioned at the reception position Q1. When the reception unit 43 is positioned at the reception position Q1, the reception unit 43 is positioned on the moving locus of the coupling unit 24 moving between the coupling position P1 and the separation position P2. Thus, when the coupling unit 24 is displaced from the separation position P2 to the coupling position P1 while the reception unit 43 is positioned at the reception position Q1, the reception unit 43 interferes with the coupling unit 24.

The retraction position Q2 is a position to which the reception unit 43 is retracted from the coupling unit 24. The retraction position Q2 is a position at which the reception unit 43 is retracted from a point vertically below the coupling unit 24. The retraction position Q2 is a position at which the reception unit 43 does not receive the liquid from the coupling unit 24. The retraction position Q2 is a position at which the reception unit 43 does not overlap with the coupling unit 24 as viewed in the vertical direction D2. The reception unit 43 illustrated in FIG. 4 and FIG. 6 is positioned at the retraction position Q2. When the reception unit 43 is positioned at the retraction position Q2, the reception unit 43 is positioned outside the moving locus of the coupling unit 24 moving between the coupling position P1 and the separation position P2. Thus, when the reception unit 43 is positioned at the retraction position Q2, the reception unit 43 does not interfere with the coupling unit 24. When the reception unit 43 is positioned at the retraction position Q2, the reception unit 43 does not interrupt coupling between the coupling unit 24 and the mounting unit 13.

The reception unit 43 includes a reception portion 44. For example, the reception portion 44 is a tray. At the reception position Q1, the reception portion 44 is positioned vertically below the coupling unit 24. The reception portion 44 includes a reception surface 45. The reception surface 45 is a surface that receives the liquid from the coupling unit 24. The reception surface 45 faces the coupling unit 24 in the reception position Q1. In an example, the reception surface 45 faces the coupling surface 26 at the reception position Q1. The reception unit 43 may include an absorption material. The absorption material may be arranged on the reception surface 45.

The reception portion 44 includes one or more bosses 46. In an example, the reception portion 44 includes four bosses 46. The boss 46 protrudes from the side surface of the reception portion 44. Two bosses 46 of the four bosses 46 protrude from the reception portion 44 in the scanning direction D1. The other two bosses 46 of the four bosses 46 protrude from the reception portion 44 in the direction opposite to the scanning direction D1. For example, the four bosses 46 are positioned symmetrically in the scanning direction D1.

The boss 46 is fitted into the accommodation unit 48, which is described later. The boss 46 is fitted into the accommodation unit 48, and hence the reception portion 44 is retained at the reception position Q1, and the reception portion 44 is retained at the retraction position Q2.

The reception unit 43 includes a grip portion 47. The grip portion 47 is configured to be gripped. For example, the grip portion 47 is gripped by a user. The grip portion 47 extends from the reception portion 44. Specifically, the grip portion 47 extends rearward from the distal end of the reception portion 44. A user moves the reception unit 43 between the reception position Q1 and the retraction position Q2 while gripping the grip portion 47.

The liquid ejection device 12 includes an accommodation unit 48. The accommodation unit 48 is configured to accommodate the reception unit 43. For example, the accommodation unit 48 is configured so that the reception unit 43 can be inserted thereinto and extracted therefrom. The accommodation unit 48 is positioned so as not to overlap with the coupling unit 24 as viewed in the vertical direction D2. The reception unit 43 is drawn from the accommodation unit 48. With this, the reception unit 43 is displaced to the reception position Q1. The reception position Q1 is a position at which the reception unit 43 protrudes from the accommodation unit 48. The reception unit 43 is pressed into the accommodation unit 48. With this, the reception unit 43 is displaced to the retraction position Q2. The retraction position Q2 is a position at which the reception unit 43 is accommodated in the accommodation unit 48.

The accommodation unit 48 includes an accommodation frame 49. The accommodation frame 49 is a frame in which the reception unit 43 positioned at the retraction position Q2 is accommodated. Specifically, the accommodation frame 49 accommodates the reception portion 44. While the reception portion 44 is accommodated in the accommodation frame 49, the grip portion 47 protrudes from the accommodation frame 49. Thus, a user easily grips the grip portion 47.

The liquid ejection device 12 includes a guide frame 50. The guide frame 50 is a frame that guides the reception unit 43. Specifically, the guide frame 50 guides the reception unit 43 protruding from the accommodation unit 48. A guide slit 51 is formed in the guide frame 50. The edge of the reception portion 44 is inserted into the guide slit 51. The reception portion 44 moves along the guide slit 51. With this, the reception portion 44 easily moves between the reception position Q1 and the retraction position Q2.

In the accommodation unit 48 and the guide frame 50, one or more accommodation openings 52 may open. In an example, a plurality of accommodation openings 52 open in the accommodation unit 48. The plurality of accommodation openings 52 open in the guide frame 50. The accommodation opening 52 is an opening into which the boss 46 is inserted. The boss 46 is inserted into the accommodation opening 52. With this, the reception unit 43 is retained. With this, the posture of the reception unit 43 is stabilized.

The accommodation opening 52 opens in the accommodation frame 49. In an example, four accommodation openings 52 open in the accommodation frame 49. When the reception unit 43 is positioned at the retraction position Q2, the four accommodation openings 52 are positioned so as to correspond to the four bosses 46. Thus, the four bosses 46 are fitted respectively into the four accommodation openings 52 opening in the accommodation frame 49. With this, the reception unit 43 is retained at the retraction position Q2.

In an example, two accommodation openings 52 open in the guide frame 50. When the reception unit 43 is positioned at the reception position Q1, the two accommodation openings 52 are positioned so as to correspond to the two bosses 46. When the reception unit 43 is positioned at the reception position Q1, the four bosses 46 are fitted into the two accommodation openings 52 opening in the accommodation frame 49 and the two accommodation openings 52 opening in the guide frame 50. With this, the reception unit 43 is retained at the reception position Q1.

### Mounting Unit

Next, the mounting unit 13 is described.

As illustrated in FIG. 1, the mounting unit 13 is coupled to the liquid ejection device 12. The mounting unit 13 is positioned to be adjacent to the liquid ejection device 12. Specifically, the mounting unit 13 is positioned to be adjacent to the coupling unit 24. In an example, the mounting unit 13 is positioned below the coupling unit 24.

The mounting unit 13 includes a unit casing body 61. The mounting unit 13 is positioned in the arrangement space A1. With this, the mounting unit 13 is coupled to the liquid ejection device 12. When the mounting unit 13 is coupled to the liquid ejection device 12, the mounting unit 13 is positioned so that the surfaces of the unit casing body 61 are flush with the surfaces of the device casing body 14. For example, the front surface of the unit casing body 61 is flush with the front surface of the device casing body 14. The side surface of the unit casing body 61 is flush with the side surface of the device casing body 14. The back surface of the unit casing body 61 is flush with the back surface of the device casing body 14. With this, the mounting unit 13 is accommodated in the foot space of the liquid ejection device 12.

The mounting unit 13 includes one or more mounting bodies 62. In an example, the mounting unit 13 includes a plurality of mounting bodies 62. The mounting body 62 is mounted on the unit casing body 61. The plurality of mounting bodies 62 is mounted on the unit casing body 61 in a laminated manner in the vertical direction D2. For example, the mounting body 62 is a cassette.

The liquid accommodation body 63 is mounted on the mounting body 62. The mounting body 62 accommodates the liquid accommodation body 63. The liquid accommodation body 63 is accommodated in the liquid. For example, the liquid accommodation body 63 is an ink pack. The liquid accommodation body 63 is removably attachable to the mounting body 62. The mounting body 62 is mounted on the unit casing body 61. With this, the liquid accommodation body 63 is mounted on the mounting unit 13. With this, the mounting unit 13 can supply the liquid from the liquid accommodation body 63. The plurality of liquid accommodation bodies 63 may accommodate a liquid of the same type, or may accommodate liquids of different types.

As illustrated in FIG. 2, the mounting unit 13 includes a unit flow path 64. The unit flow path 64 is configured so that the liquid flows therethrough. The unit flow path 64 is coupled to the liquid accommodation body 63. Specifically, the unit flow path 64 is coupled to the liquid accommodation body 63 via the mounting body 62. The unit flow path 64 is coupled to the mounting body 62 and the liquid ejection device 12. The unit flow path 64 is coupled to the coupling unit 24. The liquid is supplied from the liquid accommodation body 63 to the ejection unit 21 via the unit flow path 64.

The unit flow path 64 includes one or more supply portions 65. The supply portion 65 is a portion in which the liquid flows. The supply portion 65 is coupled to the mounting body 62. The supply portion 65 extends inside the unit casing body 61. For example, the supply portion 65 includes a tube. The unit flow path 64 includes the same number of the supply portion 65 as the liquid accommodation bodies 63. With this, the unit flow path 64 can supply the liquid from the plurality of liquid accommodation bodies 63 to the ejection unit 21.

The unit flow path 64 includes a joining unit 66. The joining unit 66 is configured to be coupled to the liquid ejection device 12. The joining unit 66 is coupled to the coupling unit 24. The joining unit 66 configures the downstream end of the unit flow path 64. Specifically, the joining unit 66 configures the downstream end of the unit flow path 64 in the direction in which the liquid flows. The joining unit 66 is coupled to the supply portion 65. For example, the joining unit 66 is a joint.

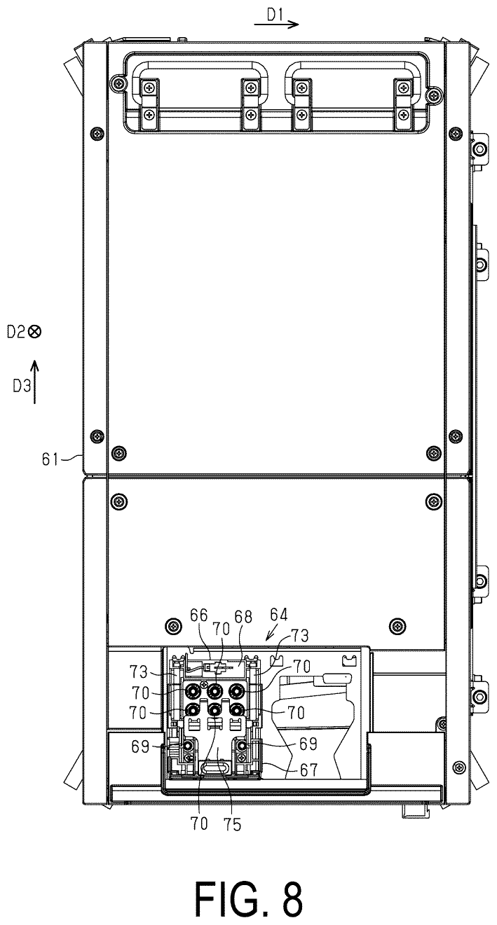

As illustrated in FIG. 8, the joining unit 66 is positioned to be exposed from the unit casing body 61. In an example, the joining unit 66 is exposed from above the unit casing body 61 in a visually recognizable manner. The joining unit 66 faces the coupling unit 24. In an example, when the mounting unit 13 is arranged in the arrangement space A1, the joining unit 66 vertically faces the coupling unit 24. The joining unit 66 is fixed to the unit casing body 61.

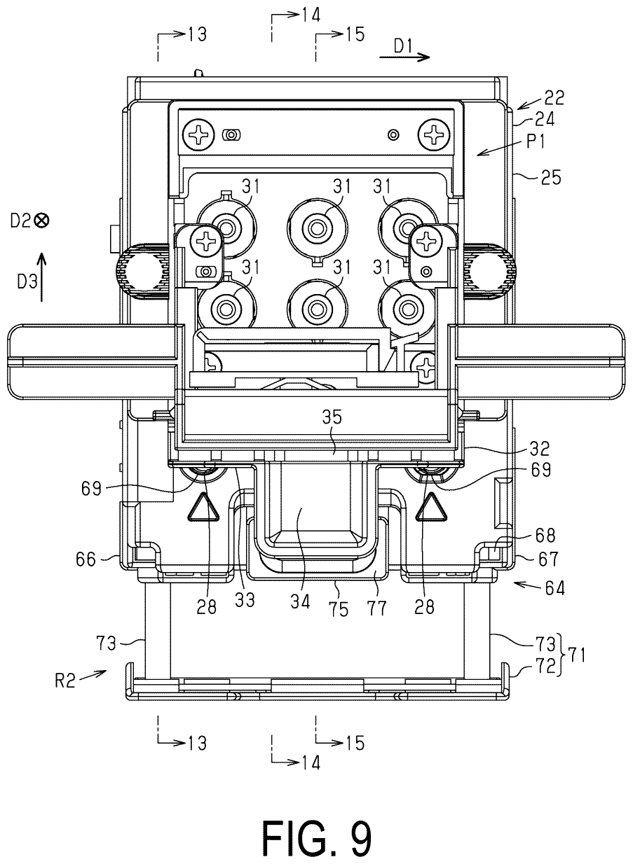

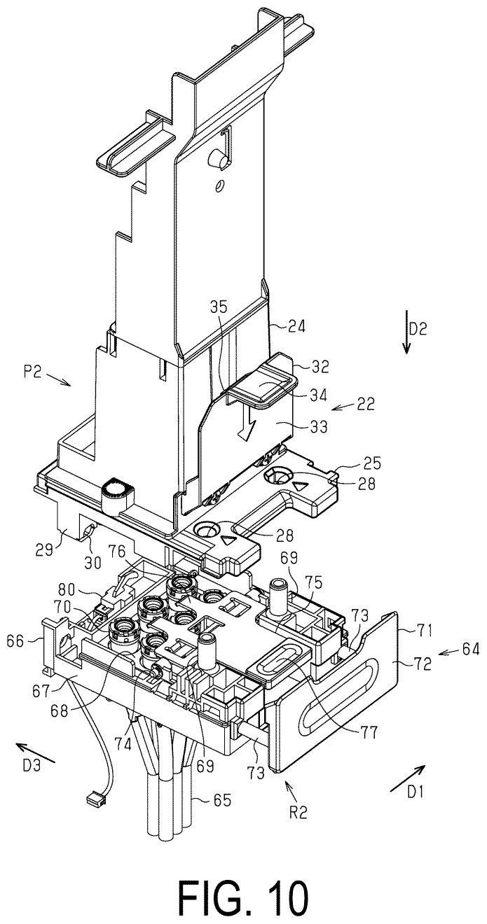

As illustrated in FIG. 8, FIG. 9, and FIG. 10, the joining unit 66 includes a joining body 67. The joining body 67 retains the supply portion 65. For example, the joining body 67 is a resin case. The joining body 67 is coupled to the coupling unit 24, and then contacts with the coupling unit 24. Specifically, the joining body 67 contacts with the coupling body 25.

The joining body 67 includes a joining surface 68. The joining surface 68 is a surface facing the liquid ejection device 12. The joining surface 68 faces the coupling unit 24. Specifically, when the joining unit 66 is coupled to the coupling unit 24, the joining surface 68 faces the coupling surface 26. In an example, the joining surface 68 faces upward.

The joining body 67 may include one or more guide pins 69. In an example, the joining body 67 includes two guide pins 69. The guide pin 69 extends vertically from the joining surface 68. For example, the guide pin 69 extends upward. The guide pin 69 is inserted into the guide hole 28. Specifically, the coupling unit 24 is displaced to the coupling position P1. With this, the guide pin 69 is inserted into the guide hole 28.

The joining unit 66 includes one or more joining tubes 70. The joining unit 66 includes the same number of joining tubes 70 as the supply portion 65. In an example, the joining unit 66 includes six joining tubes 70. The joining tube 70 is attached to the joining body 67. The joining tube 70 is positioned to protrude from the joining surface 68. In an example, the joining tube 70 faces upward.

The joining tube 70 is coupled to the supply portion 65. The joining tube 70 is inserted into the coupling tube 31, or the coupling tube 31 is inserted into the joining tube 70. With this, the joining unit 66 is coupled to the coupling unit 24. In an example, the coupling tube 31 is inserted into the joining tube 70. For example, the joining tube 70 includes scaling rubber that seals the coupling tube 31. Thus, when the coupling unit 24 is coupled to the joining unit 66, the coupling tube 31 is sealed with respect to the joining tube 70. When the joining unit 66 is coupled to the coupling unit 24, the liquid flows to the coupling unit 24 via the joining tube 70.

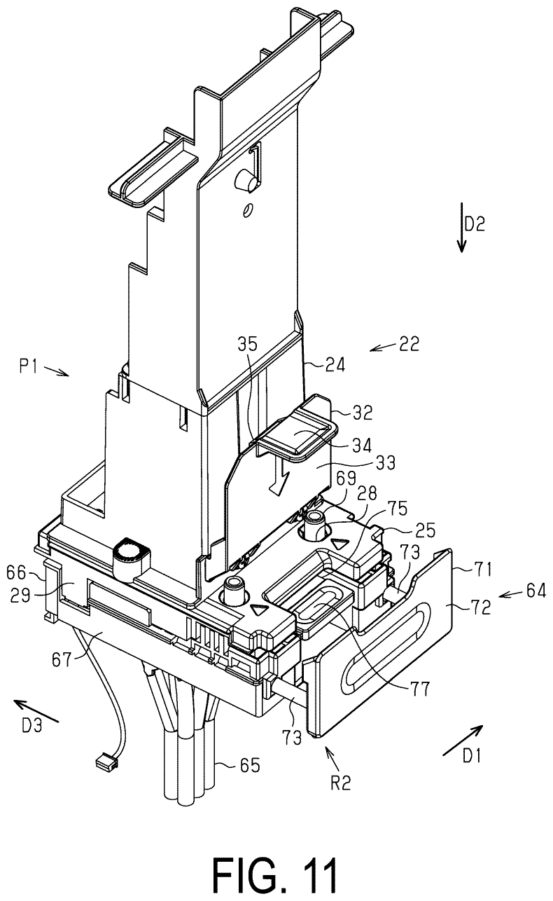

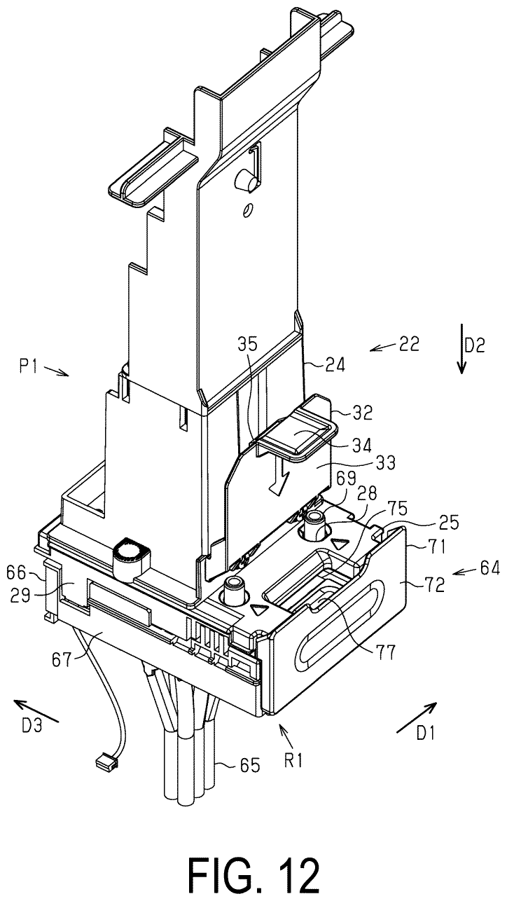

As illustrated in FIG. 10, FIG. 11, and FIG. 12, the joining unit 66 includes the lock member 71. The lock member 71 is a member that maintains the coupled state between the coupling unit 24 and the joining unit 66. The lock member 71 is attached to the joining body 67. The lock member 71 is attached to the joining body 67 so as to be displaced with respect to the joining body 67. The lock member 71 is configured to move in one direction with respect to the joining body 67.

The lock member 71 is configured to move between a lock position R1 and a cancellation position R2. In an example, the lock member 71 moves in the transport direction D3 and the direction opposite thereto. With this, the lock member 71 moves between the lock position R1 and the cancellation position R2. The lock member 71 may be displaced by moving in the scanning direction D1.

The lock position R1 is a position at which coupling between the coupling unit 24 and the joining unit 66 is locked. The lock member 71 moves in the transport direction D3 to be displaced to the lock position R1. The cancellation position R2 is a position at which coupling between the coupling unit 24 and the joining unit 66 is canceled. The lock member 71 moves in the direction opposite to the transport direction D3 to be displaced to the cancellation position R2. The lock member 71 illustrated in FIG. 10 and FIG. 11 is positioned at the cancellation position R2. The lock member 71 illustrated in FIG. 12 is positioned at the lock position R1.

The lock member 71 includes a lock cover 72. The lock cover 72 is configured to be gripped. For example, the lock cover 72 is gripped by a user. A user displaces the lock member 71 while gripping the lock cover 72.

The lock cover 72 is positioned at the lock position R1 to cover a lever 75, which is described later. Thus, when the lock cover 72 is positioned at the lock position R1, it is difficult for a user to access the lever 75. When the lock cover 72 is displaced to the cancellation position R2, the lock cover 72 is separated from the lever 75. With this, a user easily accesses the lever 75. The lock cover 72 covers the lever 75. With this, a user can be guided to operate the lock member 71, and then operate the lever 75.

The lock member 71 includes one or more lock pins 73. The lock member 71 includes the same number of lock pins 73 as the insertion portion 29. In an example, the lock member 71 includes two lock pins 73. The lock pin 73 extends from the lock cover 72. The lock pin 73 extends in one direction. The lock pin 73 extends in a direction in which the lock member 71 moves. In an example, the lock pin 73 extends in the transport direction D3. The lock pin 73 is inserted into the joining body 67.

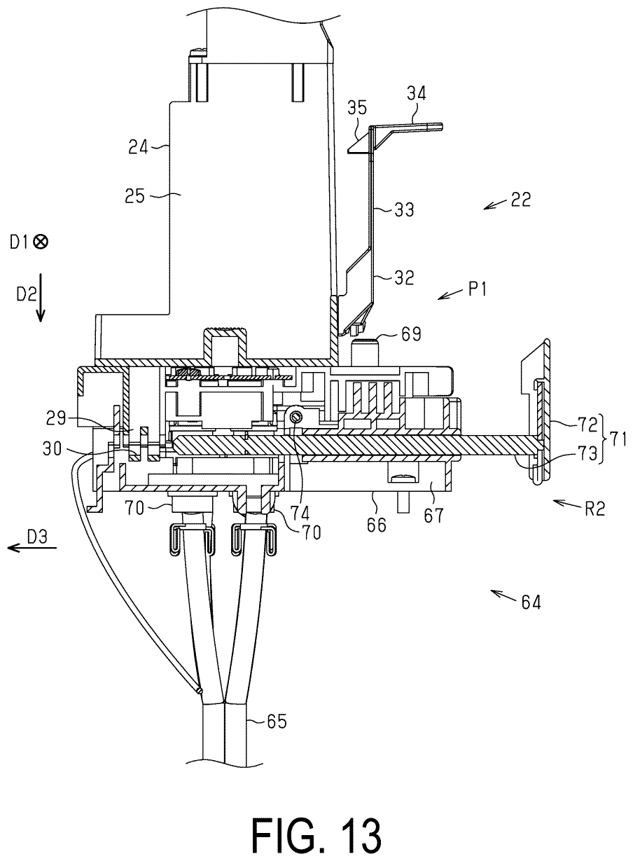

As illustrated in FIG. 13, the lock pin 73 is inserted into the insertion portion 29. Specifically, the lock pin 73 is inserted into the insertion opening 30. When the joining unit 66 is coupled to the coupling unit 24, the lock pin 73 is positioned coaxially with the insertion opening 30. In other words, when the coupling unit 24 is coupled to the joining unit 66, the insertion portion 29 is positioned on the extension line of the lock pin 73. Thus, the lock pin 73 moves in the transport direction D3 while the joining unit 66 is coupled to the coupling unit 24. With this, the lock pin 73 is inserted into the insertion opening 30. The lock pin 73 is inserted into the insertion opening 30, and then coupling between the coupling unit 24 and the joining unit 66 is locked.

When the lock member 71 is positioned at the lock position R1 before the coupling unit 24 is coupled to the joining unit 66, the lock pin 73 interrupts coupling between the coupling unit 24 and the joining unit 66. When the coupling unit 24 is displaced to the coupling position P1, the lock pin 73 interferes with the insertion portion 29. Thus, the coupling unit 24 cannot be displaced to the coupling position P1. The lock pin 73 interferes with the insertion portion 29. With this, a user can be guided to displace the coupling unit 24 to the coupling position P1 while the lock member 71 is positioned at the cancellation position R2.

The joining unit 66 includes a shaft 74. The shaft 74 is attached to the joining body 67. For example, the shaft 74 extends in the scanning direction D1. For example, the shaft 74 extends in the scanning direction D1 between the joining tube 70 and the guide pin 69 in the transport direction D3. The shaft 74 supports the lever 75.

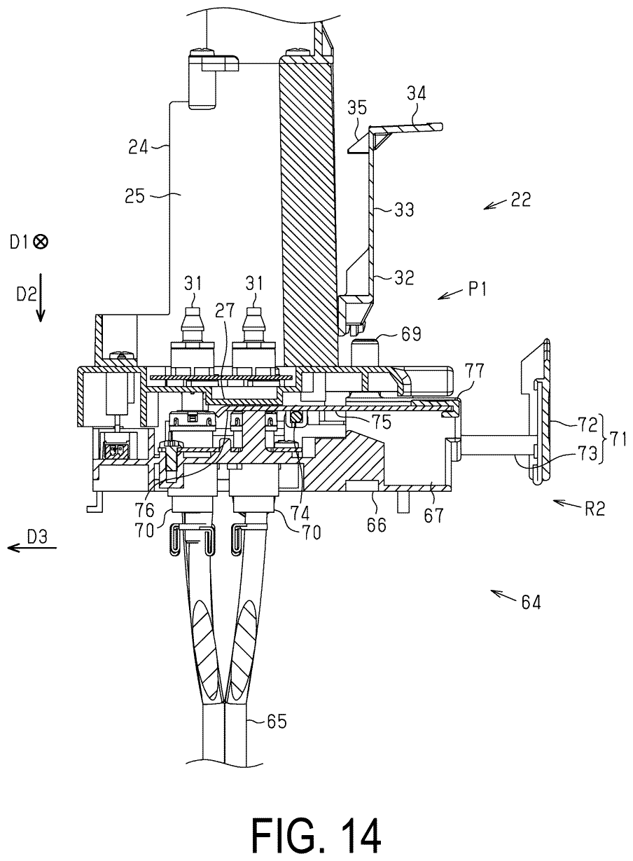

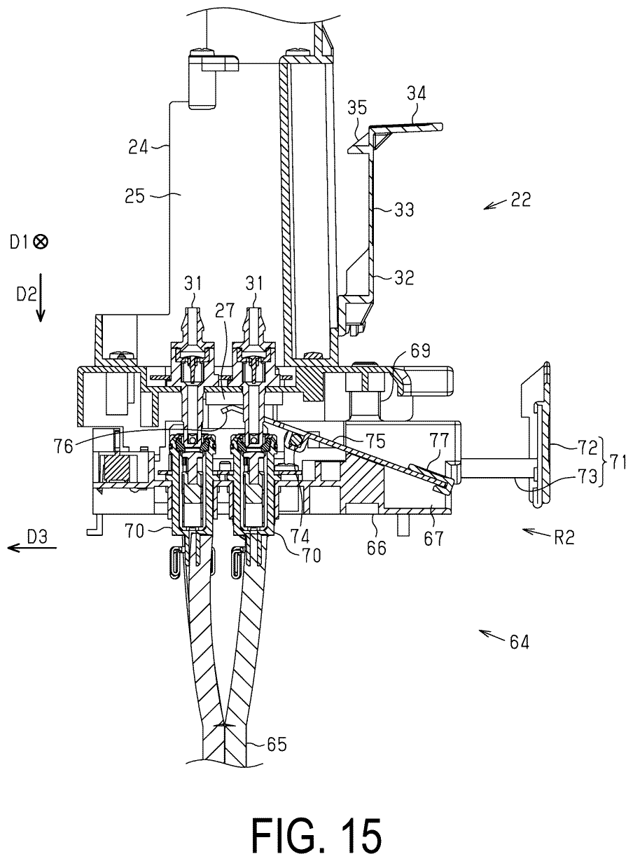

As illustrated in FIG. 14 and FIG. 15, the joining unit 66 includes the lever 75. The lever 75 is attached to the joining body 67. Specifically, the lever 75 is attached to the shaft 74. The lever 75 is attached to the shaft 74, and hence is attached to the joining body 67.

The lever 75 rotates about the shaft 74 as a center. While the coupling unit 24 is coupled to the joining unit 66, the lever 75 is sandwiched between the coupling unit 24 and the joining body 67. The lever 75 rotates to contact the coupling unit 24 so that the coupling unit 24 and the joining body 67 are separated from each other. Specifically, the lever 75 rotates to contact the coupling body 25 so that the coupling body 25 and the joining body 67 are separated from each other. In an example, the lever 75 rotates. With this, a force of displacing the coupling body 25 upward acts so that the joining body 67 is separated from the coupling body 25. When the coupling body 25 and the joining body 67 are separated from each other, coupling between the coupling unit 24 and the joining unit 66 is canceled.

The lever 75 includes a first end portion 76 and a second end portion 77. The first end portion 76 is positioned between the coupling unit 24 and the joining body 67. Specifically, the first end portion 76 is positioned between the coupling body 25 and the joining body 67. The first end portion 76 is a portion sandwiched between the coupling unit 24 and the joining body 67. Specifically, the first end portion 76 is a portion sandwiched between the coupling body 25 and the joining body 67. In an example, the first end portion 76 contacts with the pressure reception portion 27. The first end portion 76 extends to avoid the joining tube 70. The second end portion 77 is a portion that protrudes from between the coupling unit 24 and the joining body 67. The second end portion 77 is a portion that is not sandwiched between the coupling body 25 and the joining body 67. Thus, the second end portion 77 can easily be gripped by a user. The second end portion 77 is covered with the lock cover 72 positioned at the lock position R1.

A user rotates the lever 75 while gripping the second end portion 77. In an example, a user presses down the second end portion 77. With this, the first end portion 76 is lifted up. The first end portion 76 presses up the pressure reception portion 27. The lever 75 presses up the coupling unit 24 so that the coupling unit 24 is separated from the joining unit 66. As a result, coupling between the coupling unit 24 and the joining unit 66 is canceled.

When coupling between the coupling unit 24 and the joining unit 66 is canceled, the coupling unit 24 may sometimes be difficult to remove from the joining unit 66. This is because, for example, the sealing rubber of the joining tube 70 sticks onto the coupling tube 31. In view of this, the lever 75 makes it easier to remove the coupling unit 24 from the joining unit 66.

As illustrated in FIG. 10, the mounting unit 13 may include a detection unit 80. The detection unit 80 is configured to detect coupling between the coupling unit 24 and the joining unit 66. For example, the detection unit 80 is a contact sensor. The detection unit 80 is attached to the joining body 67. When the coupling unit 24 and the joining unit 66 are coupled to each other, the detection unit 80 is pressed against the coupling body 25. With this, the detection unit 80 detects coupling between the coupling unit 24 and the joining unit 66. The detection unit 80 detects coupling between the coupling unit 24 and the joining unit 66. With this, a signal indicating coupling between the coupling unit 24 and the joining unit 66 may be transmitted to the liquid ejection device 12. The detection unit 80 detects coupling between the coupling unit 24 and the joining unit 66. With this, a display indicating coupling between the coupling unit 24 and the joining unit 66 may be turned on.

### Operations and Effects of Embodiment

Next, operations and effects of the above-mentioned examples are described.
(1) The reception unit 43 is positioned vertically below the coupling unit 24. When the mounting unit 13 is removed from the coupling unit 24, the liquid may drip down from the coupling unit 24. According to the configuration described above, the reception unit 43 receives the liquid dripping down from the coupling unit 24. With this, the risk of contamination in the periphery of the liquid ejection device 12 can be lowered.
(2) The reception unit 43 is configured to move between the reception position Q1 and the retraction position Q2. According to the configuration described above, the reception unit 43 is displaced to the retraction position Q2. With this, the coupling unit 24 is easily coupled to the mounting unit 13.
(3) The accommodation unit 48 is positioned so as not to overlap with the coupling unit 24 as viewed in the vertical direction D2. The reception position Q1 is a position at which the reception unit 43 protrudes from the accommodation unit 48. The retraction position Q2 is a position at which the reception unit 43 is accommodated in the accommodation unit 48. According to the configuration described above, the reception unit 43 is accommodated in the accommodation unit 48. With this, the risk that a user unintentionally touches the liquid received by the reception unit 43 can be lowered.
(4) The coupling unit 24 is configured to be coupled to the mounting unit 13 positioned vertically therebelow. When the reception unit 43 is positioned at the retraction position Q2, the reception unit 43 is retracted from a point vertically below the coupling unit 24. Thus, coupling between the mounting unit 13 and the coupling unit 24 is not interrupted. When the reception unit 43 is positioned at the reception position Q1, the reception unit 43 is positioned vertically below the coupling unit 24. Thus, coupling between the mounting unit 13 and the coupling unit 24 is interrupted. According to the configuration described above, when the mounting unit 13 is coupled to the coupling unit 24, a user can be guided to displace the reception unit 43 to the retraction position Q2.
(5) The reception unit 43 includes the grip portion 47 that can be gripped. According to the configuration described above, a user easily moves the reception unit 43.
(6) The retaining unit 36 retains the coupling unit 24 positioned at the separation position P2. According to the configuration described above, the risk that the coupling unit 24 is unintentionally displaced from the separation position P2 to the coupling position P1 due to vibration, an impact, or the like can be lowered. The risk that the coupling unit 24 collides with the mounting unit 13 can be lowered.
(7) The lever 75 rotates to contact the coupling unit 24 so that the coupling unit 24 and the joining body 67 are separated from each other. According to the configuration described above, a user can easily cancel coupling between the coupling unit 24 and the joining unit 66 by rotating the lever 75.
(8) The first end portion 76 is positioned between the coupling unit 24 and the joining body 67. The second end portion 77 protrudes from between the coupling unit 24 and the joining body 67. According to the configuration described above, a user easily grips the second end portion 77. Thus, a user easily cancels coupling between the coupling unit 24 and the joining unit 66.
(9) The coupling unit 24 includes the coupling body 25 in which the insertion opening 30 opens. The lock pin 73 is inserted into the insertion opening 30. According to the configuration described above, the lock pin 73 is inserted into the insertion opening 30. With this, the coupled state between the coupling unit 24 and the joining unit 66 is maintained. With this, the risk of unintentional cancel of coupling between the coupling unit 24 and the joining unit 66 can be lowered.
(10) The liquid ejection system 11 includes the detection unit 80 that detects coupling between the coupling unit 24 and the joining unit 66. According to the configuration described above, the risk that a failure occurs to coupling between the coupling unit 24 and the joining unit 66 can be lowered.

### Modifications

The above-mentioned examples may be modified as follows for implementation. The above-mentioned examples and the following modifications may be combined for implementation insofar as they are not technically inconsistent.
The coupling unit 24 may include the lock member 71. In this case, the lock member 71 is attached to the coupling body 25. In this modification, the joining body 67 includes the insertion portion 29. The lock member 71 is displaced to the lock position R1 and the cancellation position R2 by moving moves with respect to the coupling body 25.
the coupling unit 24 may include the lever 75. In this case, the lever 75 is attached to the coupling body 25. In this modification, the joining body 67 includes the pressure reception portion 27. The lever 75 rotates to press down the joining unit 66 with respect to the coupling unit 24.
The lever 75 rotates to lift up the second end portion 77. With this, coupling between the coupling unit 24 and the joining unit 66 may be canceled. For example, the lever 75 may press up the coupling unit 24 with respect to the joining unit 66 as the second end portion 77 is lifted up.
Instead of displacing the coupling unit 24 between the coupling position P1 and the separation position P2, the joining unit 66 may be configured to be displaced between the coupling position P1 and the separation position P2. For example, the joining unit 66 may be configured to move in the vertical direction D2 and the direction opposite thereto. In this case, the mounting unit 13 may include the retaining unit 36.
The detection unit 80 may be provided to, for example, the liquid ejection device 12 instead of the mounting unit 13. In this case, the detection unit 80 is attached to the coupling body 25. The detection unit 80 is pressed against the joining body 67. With this, coupling between the coupling unit 24 and the joining unit 66 is detected.
The liquid ejected from the ejection unit 21 is not limited to ink, but may be a liquid member in which particles of functional materials are dispersed or mixed in liquid or the like, for example. For example, the ejection unit 21 may eject a liquid member in which materials such as electrode materials or pixel materials used for manufacturing liquid crystal displays, electroluminescence displays and surface-emitting displays are dispersed or dissolved.

### Technical Ideas

The following describes technical ideas and operational effects that are derived from the above-described examples and modifications.
(A) A liquid ejection device is a liquid ejection device being coupled to a mounting unit on which a liquid accommodation body configured to accommodate a liquid is mounted, the liquid ejection device including an ejection unit configured to eject the liquid, a device flow path extending from the ejection unit, and a reception unit configured to receive the liquid, wherein the device flow path includes a coupling unit to be coupled to the mounting unit, and the reception unit is positioned vertically below the coupling unit. When the mounting unit is removed from the coupling unit, the liquid may drip down from the coupling unit. According to the configuration described above, the reception unit receives the liquid dripping down from the coupling unit. With this, the risk of contamination in the periphery of the liquid ejection device can be lowered.
(B) In the liquid ejection device described above, the reception unit may be configured to move between a reception position vertically below the coupling unit and a retraction position to which the reception unit is retracted from a point vertically below the coupling unit. According to the configuration described above, the reception unit is displaced to the retraction position. With this, the coupling unit is easily coupled to the mounting unit.
(C) The liquid ejection device described above may include an accommodation unit configured to accommodate the reception unit, wherein the accommodation unit may be positioned so as not to overlap with the coupling unit as viewed in a vertical direction, the reception position may be a position at which the reception unit protrudes from the accommodation unit, and the retraction position may be a position at which the reception unit is accommodated in the accommodation unit. According to the configuration described above, the reception unit is accommodated in the accommodation unit. With this, the risk that a user unintentionally touches the liquid received by the reception unit can be lowered.
(D) In the liquid ejection device described above, the coupling unit may be configured to be coupled to the mounting unit positioned vertically therebelow. According to the configuration described above, when the reception unit is positioned at the retraction position, the reception unit does not interrupt coupling between the mounting unit and the coupling unit. When the reception unit is at the reception position, the reception unit interrupts coupling between the mounting unit and the coupling unit. Thus, when the mounting unit and the coupling unit are coupled to each other, a user can be guided to displace the reception unit to the retraction position.
(E) In the liquid ejection device described above, the reception unit may include a grip portion configured to be gripped. According to the configuration described above, a user can easily move the reception unit.
(F) The liquid ejection device described above may include a retaining unit configured to retain the coupling unit, wherein the coupling unit may be configured to move between a coupling position at which the coupling unit is coupled to the mounting unit and a separation position at which the coupling unit is separated from the mounting unit, and the retaining unit may retain the coupling unit positioned at the separation position. According to the configuration described above, the risk that the coupling unit is unintentionally displaced from the separation position to the coupling position due to vibration, an impact, or the like can be lowered. The risk that the coupling unit collides with the mounting unit can be lowered.
(G) A liquid ejection system includes the liquid ejection device described above and the mounting unit. According to the configuration described above, the effects similar to those of the liquid ejection device described above can be exerted.
(H) In the liquid ejection system described above, the mounting unit may include a mounting body on which the liquid accommodation body is mounted, and a unit flow path extending from the liquid accommodation body, the unit flow path may include a joining portion to be coupled to the coupling unit, the joining unit may include a joining body being coupled to the coupling unit and contacting with the coupling unit, and a lever attached to the joining body, and the lever may rotate to contact the coupling unit so that the coupling unit and the joining body are separated from each other. According to the configuration described above, a user rotates the lever. With this, coupling between the coupling unit and the joining unit can easily be canceled.
(I) In the liquid ejection system described above, the lever may include a first end potion and a second end portion, the first end portion may be positioned between the coupling unit and the joining body, and the second end portion may protrude from between the coupling unit and the joining body. According to the configuration described above, a user easily grips the second end portion. Thus, a user easily cancels coupling between the coupling unit and the joining unit.
(J) In the liquid ejection system described above, the joining unit may include a lock member being attached to the joining body and maintaining the coupling unit and the joining unit in a coupled state, the lock member may include a lock pin extending in one direction, and may be configured to move in the one direction with respect to the joining body, and the coupling unit may include a coupling body in which an insertion opening into which the lock pin is inserted opens. According to the configuration described above, the lock pin is inserted into the insertion opening. With this, the coupled state between the coupling unit and the joining unit is maintained. With this, the risk of unintentional cancel of coupling between the coupling unit and the joining unit can be lowered.
(K) The liquid ejection system described above may include a detection unit configured to detect coupling between the coupling unit and the joining unit. According to the configuration described above, the risk that a failure occurs to coupling between the coupling unit and the joining unit can be lowered.

What is claimed is:

1. A liquid ejection device being coupled to a mounting unit on which a liquid accommodation body configured to accommodate a liquid is mounted, the liquid ejection device comprising:
an ejection unit configured to eject the liquid;
a device flow path extending from the ejection unit; and
a reception unit configured to receive the liquid, wherein
the device flow path includes a coupling unit to be coupled to the mounting unit, and
the reception unit is positioned vertically below the coupling unit.

2. A liquid ejection device according to claim 1, wherein
the reception unit is configured to move between a reception position vertically below the coupling unit and a retraction position to which the reception unit is retracted from a point vertically below the coupling unit.

3. A liquid ejection device according to claim 2, comprising:
an accommodation unit configured to accommodate the reception unit, wherein
the accommodation unit is positioned so as not to overlap with the coupling unit as viewed in a vertical direction,
the reception position is a position at which the reception unit protrudes from the accommodation unit, and
the retraction position is a position at which the reception unit is accommodated in the accommodation unit.

4. A liquid ejection device according to claim 2, wherein
the coupling unit is configured to be coupled to the mounting unit positioned vertically below the coupling unit.

5. A liquid ejection device according to claim 2, wherein
the reception unit includes a grip portion configured to be gripped.

6. A liquid ejection device according to claim 1, comprising:
a retaining unit configured to retain the coupling unit, wherein
the coupling unit is configured to move between a coupling position at which the coupling unit is coupled to the mounting unit and a separation position at which the coupling unit is separated from the mounting unit, and
the retaining unit retains the coupling unit positioned at the separation position.

7. A liquid ejection system comprising:
the liquid ejection device according to claim 1; and
the mounting unit.

8. A liquid ejection system according to claim 7, wherein
the mounting unit includes:
a mounting body on which the liquid accommodation body is mounted; and
a unit flow path extending from the liquid accommodation body,
the unit flow path includes a joining portion to be coupled to the coupling unit,
the joining unit includes:
a joining body being coupled to the coupling unit and contacting with the coupling unit; and
a lever attached to the joining body, and
the lever rotates to contact the coupling unit so that the coupling unit and the joining body are separated from each other.

9. A liquid ejection system according to claim 8, wherein
the lever includes a first end potion and a second end portion,
the first end portion is positioned between the coupling unit and the joining body, and
the second end portion protrudes from between the coupling unit and the joining body.

10. A liquid ejection system according to claim 8, wherein
the joining unit includes a lock member being attached to the joining body and maintaining the coupling unit and the joining unit in a coupled state,
the lock member includes a lock pin extending in one direction, and is configured to move in the one direction with respect to the joining body, and
the coupling unit includes a coupling body in which an insertion opening into which the lock pin is inserted opens.

11. A liquid ejection system according to claim 8. comprising:
a detection unit configured to detect coupling between the coupling unit and the joining unit.
